(19) United States
(12) Patent Application Publication
(10) Pub. No.: US 2007/0198864 A1
(43) Pub. Date: Aug. 23, 2007

(54) Systems and methods for determining and using power profiles for software programs executing on data processors

(75) Inventor: Satoru Takase, Austin, TX (US)

Correspondence Address: LAW OFFICES OF MARK L. BERRIER, 3811 BEE CAVES ROAD, SUITE 204, AUSTIN, TX, 78746, US

(73) Assignee: Toshiba America Electronic Components

(21) Appl. No.: 11/358,535

(22) Filed: Feb. 21, 2006

(51) Int. Cl. G06F 1/26

(52) U.S. Cl. 713/300

(57) ABSTRACT

Systems and methods for determining power profiles associated with software programs. The power profiles may be multi-value profiles and they may be used to modify the programs to alter the power usage characteristics and corresponding power profiles of the programs. One embodiment comprises a system including a data processor, a power measurement unit and a memory. The power measurement unit is coupled to the data processor to determine a profile of the power used by the data processor during execution of a software program. The memory stores the power profile. The power measurement unit and memory may be integrated on the same chip as the data processor. The system may determine and store the power profile without interrupting execution of the program. The power profile may include multiple power level values associated with intervals during the execution of the program, over-threshold counts, or other power metrics.

### BACKGROUND

1. Field of the Invention

The present invention relates generally to electronic devices, and more particularly to systems and methods for determining profiles of the power used by software programs at different points in their execution.

2. Related Art

Integrated circuits such as microprocessors are becoming increasingly complex. The circuit components (e.g., transistors, diodes, resistors and the like) that form these devices are, at the same time, becoming increasingly small so that more and more functions may be performed by a particular integrated circuit. As the number of circuit components and functions grows, the amount of power that is typically consumed by these integrated circuits typically also increases. With the increased power consumption of the circuits, the amount of heat generated within the circuits increases as well. This heat may affect the performance of the devices, and may even cause the devices to fail.

As a result of the dangers presented by the generation of increased amounts of heat in electronic devices, management of the temperatures within these devices is becoming increasingly important. The devices are often designed with temperature management in mind, and may include various hardware features to help control temperatures in the devices. For instance, the devices may include thermal sensing circuits to detect temperatures, and control systems to reduce the speed or number of operations performed by the devices in case the temperatures become too high.

While a great deal of effort has been expended on the designs of the devices and hardware features that sense and control temperatures, relatively little effort has been focused on the design of software that is run by the devices. For instance, it has been recognized that different types of software instructions require varying levels of computational power (e.g., floating point operations are more computationally intensive than integer operations,) but this information has been used to modify the hardware designs rather than the software designs. For instance, a microprocessor may be designed to switch contexts to perform lighter contexts rather than heavier ones (e.g., contexts with primarily integer operations instead of ones with primarily floating point operations.)

Software-oriented approaches to addressing power-related concerns have not been widely developed. Some are cumbersome, requiring external host computers or test benches. Some are designed for relatively narrow purposes, such as determining power requirements for individual instructions. Still others provide information that is less precise than may be desirable (e.g., they may simply provide a power level that is averaged over an entire program. These systems are not well designed for easily determining more precise power information, such as the manner in which power levels vary during execution of a program.

It would be desirable to provide systems and methods for identifying the power characteristics of software programs (e.g., power requirements as a function of time) and modifying the programs to improve their power characteristics.

### SUMMARY OF THE INVENTION

One or more of the problems outlined above may be solved by the various embodiments of the invention. Broadly speaking, the invention includes systems and methods for determining power profiles associated with software programs. The power profiles may be multi-value profiles and they may be used to modify the programs to alter the power usage characteristics and corresponding power profiles of the programs.

One embodiment comprises a system including a data processor, a power measurement unit and a memory. The power measurement unit is coupled to the data processor and configured to determine a profile of the power used by the data processor during execution of a software program. The memory is configured to store the power profile associated with the software program. The power measurement unit and memory are preferably integrated on the same chip as the data processor.

In one embodiment, the system is configured to determine and store the power profile without interrupting execution of the program. In one embodiment, the power profile includes multiple power level values, each of which is associated with a corresponding interval during the execution of the program. Each interval may include execution of one or more instructions, and the intervals are preferably equal. In one embodiment, the power measurement unit includes a comparator configured to compare the power used by the data processor with a threshold level. These over-threshold events may be recorded in a single value for the entire program, or they may be recorded for intervals within the program.

Another embodiment comprises a method including executing a software program on a data processor, monitoring the power used by the data processor to execute the program, and then determining and storing a power profile for the program. The power profile may then be used to modify the program to alter the power usage characteristics and resulting power profile.

In one embodiment, the method is performed without interrupting execution of the software program. The power profile for the program may be determined by measuring multiple power level values, each of which is associated with a corresponding interval during the execution of the program. Each interval may include execution of multiple instructions. The intervals are preferably, although not necessarily, equal. In one embodiment, the power profile for the program may be determined by comparing the power used by the data processor during each interval with a threshold power level, and counting these over-threshold events. The number of over-threshold events may be recorded for intervals within the program, or for the entire program. The power profile information may be stored in memory that is integral with the processor executing the software program, or it may be stored in an external memory.

Numerous additional embodiments are also possible.

### BRIEF DESCRIPTION OF THE DRAWINGS

Other objects and advantages of the invention may become apparent upon reading the following detailed description and upon reference to the accompanying drawings.

FIG. 1 is a flow diagram illustrating a basic method in accordance with one embodiment.

FIG. 2 is a diagram illustrating a power profile as generated in accordance with one embodiment.

FIG. 3 is a functional block diagram illustrating the components of a data processing system in accordance with one embodiment.

FIGS. 4A and 4B are a table showing an exemplary set of power measurements for a software program and a plot of the power data (a power profile.)

FIG. 5 is a functional block diagram illustrating a data processing system in accordance with an alternative embodiment.

FIGS. 6A and 6B are a diagram illustrating the comparison of the processor core's power levels to a threshold value and the resulting over-threshold profile in accordance with one embodiment.

FIG. 7 is a functional block diagram illustrating a data processing system in accordance with an alternative embodiment.

FIGS. 8A and 8B are a diagram illustrating a comparison of a processor core's power levels to a threshold value and a resulting multi-value over-threshold profile in accordance with one embodiment.

FIG. 9 is a flow diagram illustrating a method for determining a power profile for a software program and using this information to modify the program in accordance with an alternative embodiment.

FIG. 10 is a diagram illustrating the power profiles of a software program before and after modification in accordance with one embodiment.

While the invention is subject to various modifications and alternative forms, specific embodiments thereof are shown by way of example in the drawings and the accompanying detailed description. It should be understood that the drawings and detailed description are not intended to limit the invention to the particular embodiments which are described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

Broadly speaking, the invention includes systems and methods for determining the power used by software programs so that this information can be used, for example, to modify the structures of the programs and thereby improve the power usage characteristics of the programs.

In one embodiment, a microprocessor incorporates a power measurement unit and a memory for profiling power usage associated with software programs executed on the processor. The power measurement unit is configured to monitor the power used by the processor to execute the instructions of the software program. The power levels measured at different points in the execution of the program form a power profile that is stored in the memory. This information can then be used for purposes such as the analysis of the program and subsequent modification of the program to improve the power profile of the program (e.g., to reduce peaks in the power usage associated with the program.)

In this embodiment, the power measurement unit and the memory are both integral to the processor. That is, they are constructed on the same chip as the processor. The power measurement unit and memory are configured in this embodiment to determine and store the power profile of the software program as the program is executed by the processor. The profile may be more or less detailed, depending upon the requirements of a particular implementation, and may range, for example, from recording a power level associated with each instruction, to recording power levels associated with a series of intervals in the execution, to recording a number of over-threshold occurrences in the execution.

In this embodiment, the power measurement unit and the memory are configured to determine and record the power profile of a software program as the program executes. It is not necessary to send an interrupt to the processor to halt execution and determine the part of the program that is being executed. Similarly, it is not necessary to interrupt execution of the program to transfer power data off-chip to a host computer or test bench, or to store instruction or power data in an off-chip memory.

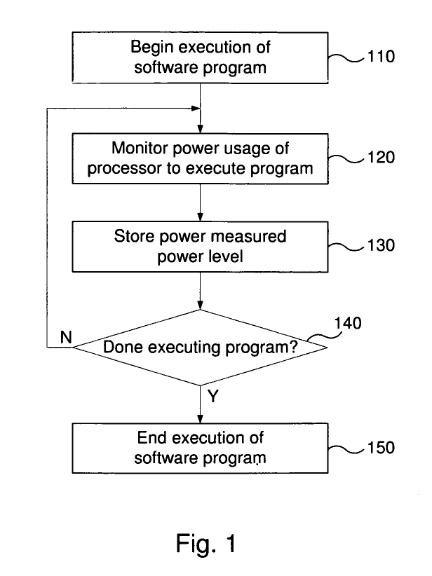

Referring to FIG. 1, a flow diagram illustrating a basic method in accordance with one embodiment is shown. The flow diagram of FIG. 1 depicts a method which is implemented in a data processor and which is designed to quickly and easily provide a power profile that is characteristic of a software program that is executed on the processor.

The method begins at block 110 when execution of the software program begins. As the program executes, the power used by the processor to execute the program is monitored (block 120.) Periodically, measurements of the power used by the processor are stored or recorded in a memory (block 130.) Decision block 140 is depicted in the figure to indicate that the monitoring of the power (see block 120) and the storing of power measurements (see block 130) continue to be performed throughout the execution of the program. When the program is done executing, the method moves to block 150, and execution of the program is completed.

It should be noted that, while the method of FIG. 1 depicts the beginning of the program's execution, monitoring of the power, and so on as discrete blocks, this is done for the purpose of simplifying the illustration. Different operations within the method may be performed discretely, continuously, or otherwise, as needed for a particular implementation. It is contemplated that the monitoring of the processor's power usage will typically be continuous, while the storing of power measurements will typically be discrete operations that occur at intervals during the execution of the program. The actual execution of the program will preferably occur without interruption. It should also be noted that the blocks shown in the figure should not be construed to imply a strict ordering of the operations. For instance, the monitoring of power usage may begin before execution of the program and continue until after execution of the program is complete.

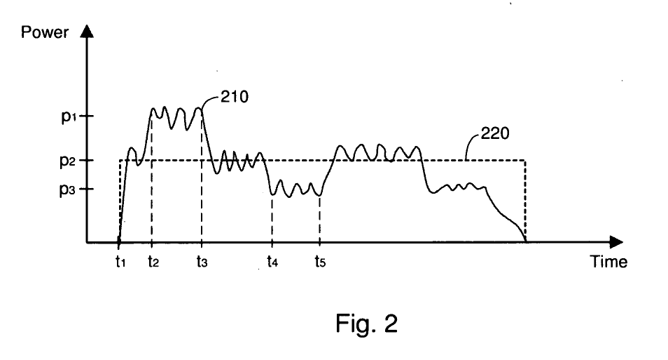

The result of the method of FIG. 1 is a power profile. An exemplary profile is illustrated in FIG. 2. Power profile 210 is a plot of the measured power levels associated with execution of the software program as a function of lime. It can be seen that execution of the program (and corresponding power usage) begins at t1. The amount of power used by the processor to execute the program varies from a high around p1 (from time t2-t3) to a low around p3 (e.g., from time t4-t5). The profile is constructed from multiple measurements that are made during the execution of the program. The number of measurements, and the intervals at which they are made, may vary in different embodiments.

In addition to power profile 210, FIG. 2 includes an indication of the average power (220) used by the processor to execute the program. The average power (which is around power p2) is illustrated for purposes of comparison, since the average power is typically the only information that is measured by conventional methods. It is easily seen from the figure that the average power provides no information as to which parts of the program use the most (or least) power. This metric would therefore be of little or no use to a software designer who wishes to identify the high-power-usage portions of the program so that they can be rewritten and made more power-efficient.

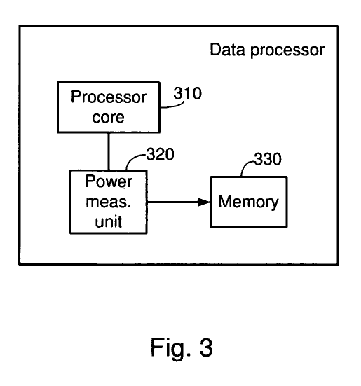

Referring to FIG. 3, a functional block diagram illustrating the components of a data processing system in accordance with one embodiment is shown. In this embodiment, the data processing system includes a processor core 310, a power measurement unit 320, and a memory 330. All of these components are constructed on a single chip (although this is not necessarily the case for other embodiments.)

In the embodiment of FIG. 3, power measurement unit 320 is coupled to processor core 310 so that it can measure the amount of power that is being used by the processor core during execution of a software program. Power measurement unit 320 may be coupled to processor core 310 in various ways. For instance, power measurement unit 320 may be connected directly to processor core 310, or it may be connected to a power source that supplies the processor core. The exact manner in which power measurement unit 320 is coupled to processor core 310 is not important, as long as the power that is used by the processor core can be determined by the power measurement unit.

At various points during execution of a software program by processor core 310, power measurement unit 320 will determine the amount of power that is being used by the processor core to execute the program. The power may be determined for a particular instant in time, or it may be determined over an interval during the execution of the program. As these power measurements are made by power measurement unit 320, they are stored in memory 330. Memory 330 may be any suitable type of memory, such as a portion of the data processor's cache memory, or a set of registers that might be reserved for the power measurements. In one embodiment, the power measurements are made at regular intervals, so the power measurements stored in memory 330 can be plotted to generate a power profile for the software program as a function of time.

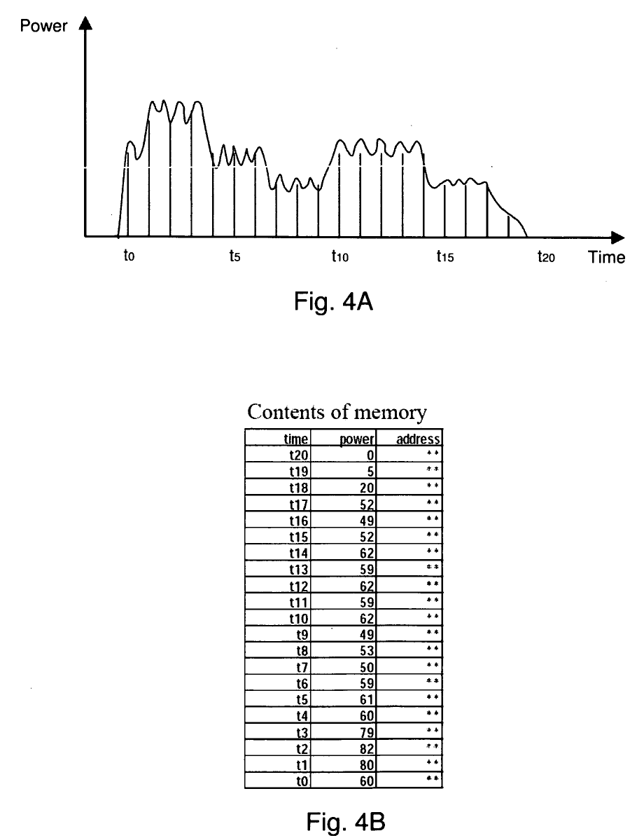

Referring to FIGS. 4A and 4B, a table showing an exemplary set of power measurements for a software program is shown, along with a plot of the power data (a power profile). The table illustrated in FIG. 4B includes three columns: time; power; and address. In one embodiment, the memory only stores the series of power measurements taken by the power measurement unit. In this embodiment, the power measurements are taken at regular intervals, so there is no need to record the actual time of each measurement—it is known that the first measurement corresponds to an initial time, and successive measurements correspond to the initial time, plus some number of intervals. For example, if the first power measurement corresponds to a time t0, the Nth measurement stored in the memory corresponds to a time t0+(N−1)Δt, where Δt is the duration of each interval. The times are provided in the table simply to assist the reader.

The data from the table of FIG. 4A is plotted in FIG. 4B. The data of FIG. 4A are shown as vertical bars. As noted above, the power measurements were made at regular intervals, so the bars are evenly spaced at t0, t1, t2, and so on. The intervals may be increased or decreased to provide the desired granularity for a particular implementation. In this example, it can be seen that the power used by the processor core typically remains at about the same level for 3-4 intervals, so the intervals could be increased. If the power fluctuated more rapidly, or if more detailed information were needed, it might be necessary to decrease the intervals at which the power measurements are made.

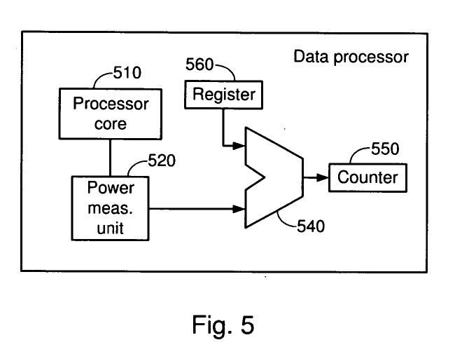

Referring to FIG. 5, a functional block diagram illustrating a data processing system in accordance with an alternative embodiment is shown. In this embodiment, the system includes a processor core 510, a power measurement unit 520, as well as a comparator 540, a counter 550, and a register 560. These components are again constructed on a single chip.

In this embodiment, power measurement unit 520 again monitors the power usage of processor core 510 as a software program is executed. However, rather than storing the power measurements made at selected intervals during execution of the program, comparator 540 is configured to compare the measured power levels to a threshold level stored in register 560, and to generate an indication of whether or not the power used by the processor core exceeds the threshold. This indication is provided to counter 550, which counts the number of times the power level exceeds the threshold.

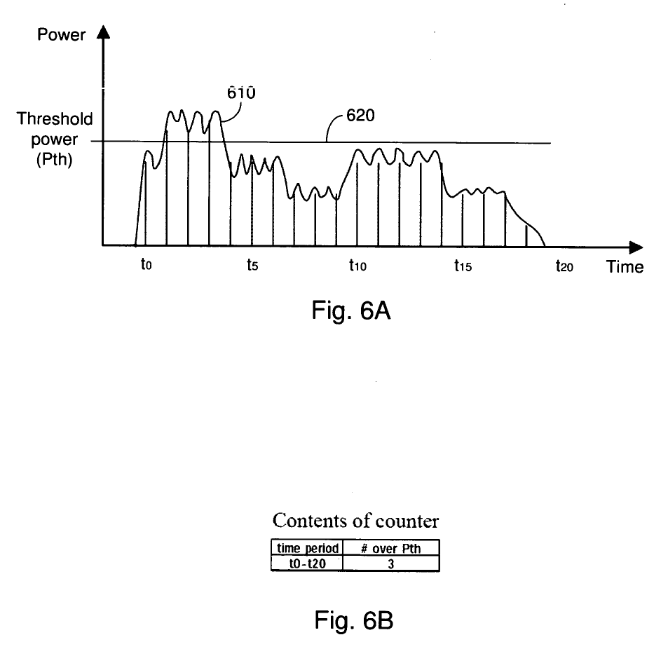

Referring to FIGS. 6A and 6B, a diagram illustrating the comparison of the processor core's power levels to the threshold value and the resulting over-threshold profile is shown. FIG. 6A includes a plot of the actual power usage 610. This plot is depicted using a dotted line because the power is not recorded as a function of time in this embodiment. This plot is provided for reference purposes to show when the power level exceeds threshold value 620, which is depicted as a solid horizontal line in the figure.

In this embodiment, the power measurement unit is configured to provide power measurements to the comparator at regular intervals. These measurements are made at times t0, t1, t2, and so on. It can be seen that the measurements taken at times t1, t2 and t3 exceed the threshold power level. At all other times, the power level is below the threshold. The counter is therefore incremented at times t1, t2 and t3, resulting in a final over-threshold count of 3.

In this embodiment, the power profile generated by the system is not a power-versus-time profile as shown in FIG. 4, but is instead a single-value profile that indicates the number of times during execution of the software program threshold power level is exceeded. Counter 550 serves, in this embodiment, as the memory/register in which the profile value is stored.

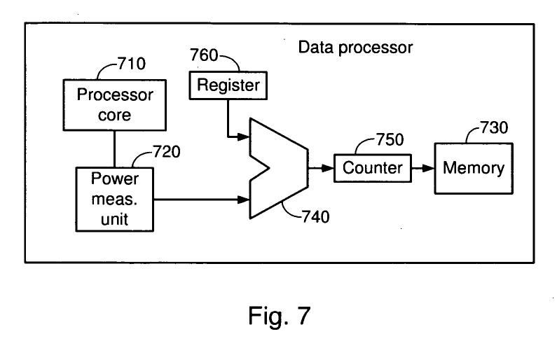

Referring to FIG. 7, a functional block diagram illustrating a data processing system in accordance with an alternative embodiment is shown. In this embodiment, the system includes a processor core 710, a power measurement unit 720, a comparator 740, a counter 750, a register 760 and a memory 730.

It can be seen that the structure of the system shown in FIG. 7 is the same as that shown in FIG. 5, except for the edition of memory 730. The operation of these two systems are very similar as well. The difference is that, while the system to FIG. 5 produces a power profile that consists of a single over-threshold value, the system of FIG. 7 is configured to produce a profile that includes multiple values corresponding to over-threshold counts for corresponding periods of time during execution of the program.

In this embodiment, power measurement unit 720 monitors the power usage of processor core 710 as the software program is executed. Comparator 740 compares the measured power levels received from power measurement unit 720 to a threshold level stored in register 760, and generates an over-threshold signal which is provided to counter 750. The value in counter 750 is periodically stored in memory 730. When the counter value is stored, the counter is reset to 0. After execution of the program, memory 730 stores a series of values corresponding to the number of times during a particular portion of the program's execution that the power usage of the processor core exceeded the threshold value.

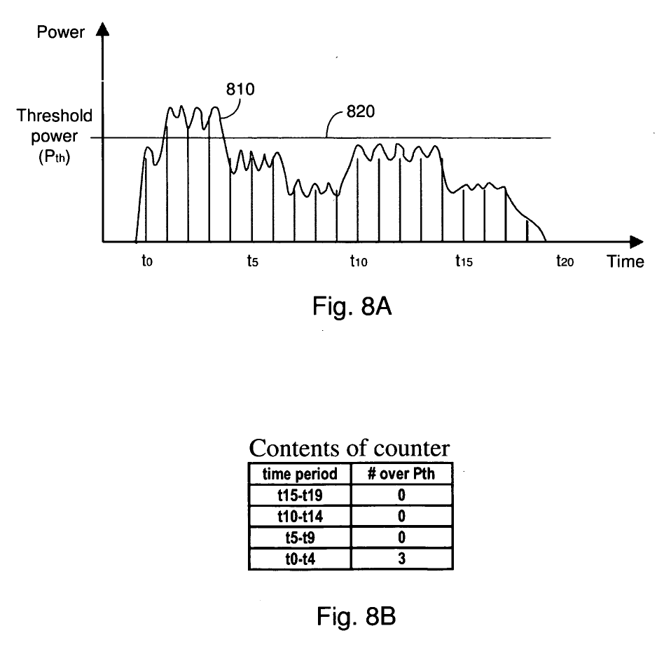

Referring to FIGS. 8A and 8B, a diagram illustrating the comparison of the processor core's power levels to the threshold value and the resulting multi-value over-threshold profile is shown. FIG. 8A includes a plot of the actual power usage 810 and the threshold value 820.

In this embodiment, the power measurement unit provides power measurements to the comparator at times t0, t1, t2, and so on. The system is configured to store the over-threshold count every fifth interval. Thus, memory 730 stores an over-threshold counts for t0-t4, t5-t9, t10-t14 and t15-t19. This multi-value profile obviously provides more information than a single-value profile and in this example localizes the over-threshold occurrences to the initial portion (t0-t4) of the program.

As noted in the background section, the advancing complexity of integrated circuits has resulted in a need for improvements in the power management of the circuits. The power profile information that is obtained as described above can be used to improve power management by improving the control that is possible in the execution of software programs in the integrated circuits.

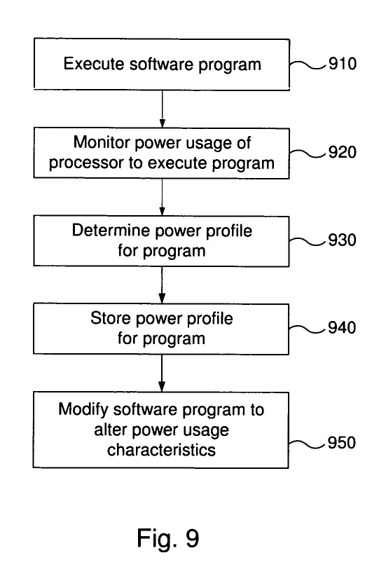

Referring to FIG. 9, a flow diagram illustrating a method for determining a power profile for a software program and using this information to modify the program in accordance with an alternative embodiment is shown. This method begins with the execution of the program on a data processor (block 910.) As the program is executed, the power usage of the data processor is monitored (block 920) and a profile is determined for the power usage of the processor (block 930.) The power profile is stored (block 940) so that it can be retrieved and used as the basis for modifying the program (block 950.)

As noted above, the power profile for the program may have a variety of forms, including single- or multiple-value over-threshold counts, and power-versus-time data. This information can be used, for example, by a software designer to determine the power usage of different portions of the program. If there are portions of the program that use too much power, the software designer may be able to use more efficient instructions or algorithms to reduce the power requirements of that portion of the program. Alternatively, the software designer may be able to shift some of the power-intensive instructions of the program to other areas, or to add less power-intensive instructions to reduce power usage.

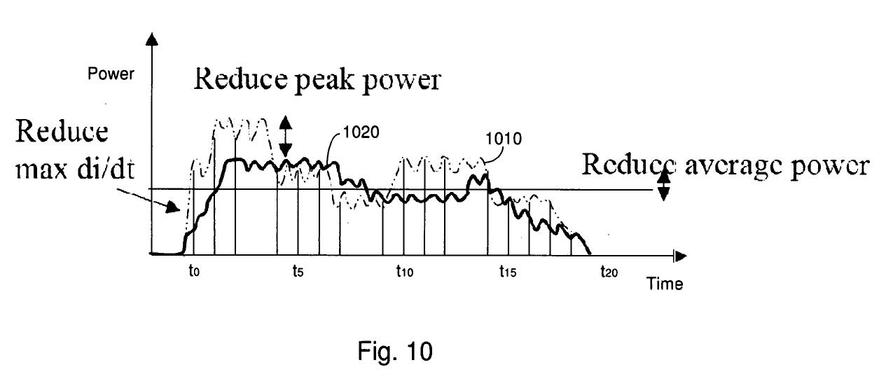

Referring to FIG. 10, a diagram illustrating the power profiles of a software program before and after modification are shown. The figure includes a plot of the initial power profile for a program (1010) as well as a plot of the power profile for the program after modification based on the initial profile (1020). It can be seen that the modifications to the program result in a reduction of the power usage, particularly in the early stages of execution (around t1-t3), where peaks occurred in the initial power profile. Additionally, the changes reduce the average power used by the program. The modifications also result in less power fluctuations throughout the execution of the program, which is beneficial because of problems that are associated with rapid changes in current (high di/dt.)

Those of skill in the art will understand that the information and signals described above may be represented using any of a variety of different technologies and techniques. For example, data, instructions, commands, information, signals, bits, symbols, and the like may be represented by voltages, currents, electromagnetic waves, magnetic fields or particles, optical fields or particles, or any combination thereof. The information and signals may be communicated between components of the disclosed systems using any suitable transport media, including wires, metallic traces, vias, optical fibers, and the like.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with application specific integrated circuits (ASICs), field programmable gate arrays (FPGAs), general purpose processors, digital signal processors (DSPs) or other logic devices, discrete gates or transistor logic, discrete hardware components, or any combination thereof designed to perform the functions described herein. A data purpose processor may be any conventional processor, controller, microcontroller, state machine or the like. A processor may also be implemented as a combination of computing devices. Memories may include counters, registers, RAM, on-chip caches, external memory, or the like.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein and recited within the following claims.

What is claimed is:

1. A system comprising:
a data processor;
a power measurement unit configured to determine power used by the data processor during execution of a software program; and
a memory configured to store a power profile associated with the software program, wherein the power profile is determined by the power measurement unit.

2. The system of claim 1, wherein the power measurement unit is configured to determine the power profile during execution of the software program and the memory is configured to store the power profile without interrupting execution of the software program.

3. The system of claim 1, wherein the power profile comprises multiple power level values, wherein each of the power level values is associated with a corresponding interval during the execution of the software program.

4. The system of claim 3, wherein each interval includes execution of multiple instructions.

5. The system of claim 3, wherein the intervals are substantially equal.

6. The system of claim 1, wherein the power measurement unit includes a comparator configured to compare a power used by the data processor during each of multiple intervals with a threshold power level, and wherein the power profile comprises a single value indicating a number of intervals during which the threshold power level is exceeded.

7. The system of claim 1, wherein the power measurement unit includes a comparator configured to compare a power used by the data processor during each of multiple intervals with a threshold power level, and wherein the power profile comprises multiple values, wherein each value is associated with a group of intervals and wherein each value indicates a number of intervals in the group during which the threshold power level is exceeded.

8. The system of claim 1, wherein the power measurement unit and the memory are integral with the data processor.

9. A method comprising:
executing a software program on a data processor;
monitoring power used by the data processor during execution of the software program;
determining a power profile for the software program; and
storing the power profile for the software program.

10. The method of claim 9, wherein monitoring the software program, determining the power profile and storing the power profile are performed during execution of the software program and without interrupting execution of the software program.

11. The method of claim 9, wherein determining the power profile for the software program comprises determining multiple power level values, wherein each of the power level values is associated with a corresponding interval during the execution of the software program.

12. The method of claim 11, wherein each interval includes execution of multiple instructions.

13. The method of claim 11, wherein the intervals are substantially equal.

14. The method of claim 9, wherein determining the power profile for the software program comprises comparing a power used by the data processor during each of multiple intervals with a threshold power level, and providing a single value indicating a number of intervals during which the-threshold power level is exceeded.

15. The method of claim 9, wherein determining the power profile for the software program comprises comparing a power used by the data processor during each of multiple intervals with a threshold power level, and providing multiple values, wherein each value is associated with a group of intervals and wherein each value indicates a number of intervals in the group during which the threshold power level is exceeded.

16. The method of claim 9, wherein monitoring the power used by the data processor during execution of the software program comprises monitoring the power using a power measurement unit which is integral with the data processor.

17. The method of claim 9, wherein storing the power profile for the software program comprises storing the power profile in a memory which is integral with the data processor.

18. The method of claim 9, further comprising modifying the software program to alter power usage characteristics of the software program associated with the power profile.

19. An integrated data processor comprising:
a processor core constructed on a single semiconductor chip;
a power measurement unit constructed on the semiconductor chip and configured to determine power used by the data processor during execution of a software program; and
a memory constructed on the semiconductor chip and configured to store a power profile associated with the software program, wherein the power profile is determined by the power measurement unit.
